(19) United States
(12) Patent Application Publication
(10) Pub. No.: US 2025/0026908 A1
(43) Pub. Date: Jan. 23, 2025

(54) INORGANIC PIGMENT TREATED WITH PHMS/PDMS COPOLYMER

(71) Applicant: Tronox LLC, Oklahoma City, OK (US)

(72) Inventors: Venkata Rama Rao Goparaju, Edmond, OK (US); Vahid Kazerooni, Oklahoma City, OK (US); Keven Stone, Meeker, OK (US)

(21) Appl. No.: 18/222,233

(22) Filed: Jul. 14, 2023

(51) Int. Cl. C08K 3/22

(52) U.S. Cl. CPC C08K 3/22; C08K 2003/2241

(57) ABSTRACT

A process for producing a treated, inorganic pigment is provided. The process comprises providing a plurality of inorganic pigment particles, and depositing an organic treating agent on the surfaces of the pigment particles to form at least one coating of the organic treating agent thereon. The organic treating agent is selected from the group consisting of a copolymer of polyhydromethylsiloxane (PHMS) and polydimethylsiloxane (PDMS) (a “PHMS/PDMS copolymer”), and a combination of a PHMS/PDMS copolymer and a neat PHMS polymer. A treated, inorganic pigment is also provided.

### BACKGROUND

Inorganic pigments are commonly added to polymers, coatings (e.g., aqueous paints), paper and other types of products to function as fillers, extenders, coloring agents and/or opacifying agents therein. Examples of white, opacifying, inorganic pigments include titanium dioxide, basic carbonate white lead, zinc sulfide, zinc oxide, antimony oxide, calcium carbonate, china and kaolin clays, iron oxide, and chromium oxide.

Due to its high refractive index, strong opacifying ability and other factors, titanium dioxide (TiO₂) has become one of the most commonly used white pigments throughout the world. Purified titanium dioxide (TiO₂) is produced from raw ore (for example, ilmenite and rutile) by either the sulfate process or the chloride process. Each process can produce the pigment in its rutile crystalline form. The sulfate process can also produce the pigment in its anatase crystalline form, which can be softer and particularly useful in certain applications.

One or more inorganic and/or organic materials are typically deposited on the surfaces of the produced inorganic pigment particles to form one or more coatings thereon. The coating(s) of inorganic and/or organic materials function to enhance specific properties and characteristics of the pigment such as the opacity, light stability, durability, wettability and/or dispersibility of the pigment.

Examples of inorganic materials that are deposited on the surfaces of inorganic pigment particles including titanium dioxide pigment particles for various purposes include hydrous, inorganic metal oxides such as silica, alumina and zirconia. Examples of organic materials that are deposited on the surfaces of inorganic pigment particles including titanium dioxide pigment particles for various purposes include organic polyols, silanes, polysiloxanes, saturated fatty acid salts, unsaturated fatty acid salts and phosphonic acids. The specific inorganic and/or organic compounds utilized depends on the desired properties and characteristics of and intended end-use application(s) for the pigment.

For example, polymethylhydrosiloxane (PMHS) is a hydrophobic, organic polymer that has been used to surface treat inorganic pigments such as titanium dioxide pigments for use in certain applications. PHMS has the following structure:

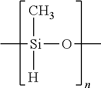

For example, PHMS has been sprayed on a finished titanium dioxide pigment in order to improve the processability of the pigment as well as the performance of the pigment in specific end-use applications.

A polycarbonate is a type of thermoplastic polymer that is widely used as an engineering plastic in various industries, including the automotive, electronics and medical appliance industries. Polycarbonate-based plastics are strong, tough materials. Titanium dioxide pigments are often added to polycarbonate compositions to impart a white color, brightness and opacity to the resulting polycarbonate articles. The titanium dioxide pigment can also minimize brittleness, fading and cracking of the polycarbonate articles.

A problem associated with the use of inorganic pigments such as titanium dioxide pigments in polycarbonate and other types of polymer compositions can be caused by the surface coating(s) on the pigment. For example, hydroxyl groups associated with certain surface coatings can interact with the polymer during processing of the polymer composition and adversely impact the stability of the polymer.

An example of a surface coating for inorganic pigments such as titanium dioxide that does not adversely interact with the polycarbonate or other polymer in a polymer composition is PHMS. However, it can be difficult to produce a finished inorganic pigment that includes a sufficient amount of PHMS to achieve the desired effect of the treatment. Unfortunately, after it is deposited on the pigment surfaces, PHMS can be lost to a significant degree in subsequent pigment finishing steps. For example, at high processing temperatures and/or the presence of steam, which are typically encountered in the pigment finishing process, 50% to 60% by weight of PHMS coated onto a titanium dioxide pigment can be lost. Hydrogen in the PHMS tends to evolve which not only creates an explosive environment but also results in degradation of the PHMS coating on the pigment particles. Although it is relatively stable at ambient temperature, the active hydrogen in PHMS is highly reactive at high temperatures.

There is a need for an organic treating agent for treating inorganic pigments such as titanium dioxide pigments that do not adversely impact the stability of polycarbonate and other types of polymer compositions and can withstand the high temperatures associated with the pigment finishing process.

### SUMMARY

In one aspect, a process for producing a treated, inorganic pigment is provided herein. The process comprises providing a plurality of inorganic pigment particles, and depositing an organic treating agent on the surfaces of the pigment particles to form at least one coating of the organic treating agent thereon. The organic treating agent is selected from the group consisting of a PHMS/PDMS copolymer, and a combination of a PHMS/PDMS copolymer and a neat PHMS polymer.

In another aspect, a treated, inorganic pigment is provided herein. The pigment comprises a plurality of inorganic pigment particles, and an organic treating agent deposited on the surfaces of the pigment particles and forming at least one coating of the organic treating agent thereon. The organic treating agent is selected from the group consisting of a PHMS/PDMS copolymer, and a combination of a PHMS/PDMS copolymer and a neat PHMS polymer.

### BRIEF DESCRIPTION OF THE DRAWINGS

FIGS. 1-4 are graphs corresponding to Example 1.

### DETAILED DESCRIPTION

The present disclosure may be understood more readily by reference to this detailed description as well as to the examples included herein. Numerous specific details are set forth in order to provide a thorough understanding of the various aspects of this disclosure. However, this detailed description is not to be considered as limiting the scope of the claims. The subject matter disclosed herein is capable of considerable modifications, alterations, combinations, and equivalents in form and function, as will be evident to those skilled in the art with the benefit of this disclosure.

Whenever a range is disclosed herein, the range includes independently and separately every member of the range extending between any two numbers enumerated within the range. Furthermore, the lowest and highest numbers of any range shall be understood to be included within the range set forth.

In one aspect, a process for producing a treated, inorganic pigment is disclosed herein. In another aspect, a treated inorganic pigment is disclosed herein.

The process disclosed herein comprises providing a plurality of inorganic pigment particles, and depositing an organic treating agent on the surfaces of the pigment particles to form at least one coating of the organic treating agent thereon. The organic treating agent is selected from the group consisting of PHMS/PDMS copolymer, and a combination of a PHMS/PDMS copolymer and a neat PHMS polymer. As used herein and in the appended claims, a “PHMS/PDMS copolymer” means a copolymer of polyhydromethylsiloxane (PHMS) and polydimethylsiloxane (PDMS). A “neat PHMS polymer” means a PHMS polymer as opposed to a copolymer that includes PHMS. When a combination of a PHMS/PDMS copolymer and a neat PHMS polymer are used, separate coatings of the PHMS/PDMS copolymer and neat PHMS polymer are formed. The PHMS/PDMS copolymer and neat PHMS polymer do not react.

Both the PHMS/PDMS copolymer and the neat PHMS polymer are hydrophobic, organic polymers. As shown by the examples set forth below, both a PHMS/PDMS copolymer by itself and a combination of a PHMS/PDMS copolymer and PHMS are much more stable at high temperatures than PHMS alone or even a simple blend of PHMS and PDMS. Hydrogen evolution and the resulting loss of the polysiloxane copolymer in subsequent pigment finishing steps is minimized. In addition, the bulk density of the treated, inorganic pigment is increased by using a PHMS/PDMS copolymer as opposed to PHMS alone.

As used herein and in the appended claims, an inorganic pigment means a particulate inorganic pigment, that is an inorganic pigment in the form of a plurality of pigment particles. For example, the inorganic pigment can be in dry powder or dry granule form. As used herein and in the appended claims, “deposited on,” formed on,” and “precipitated on” the surfaces of the inorganic pigment particles (or another component such as another coating) means deposited, formed or precipitated (as the case may be) directly or indirectly on the surfaces of the inorganic pigment particles (or other component), unless stated otherwise. For example, unless stated otherwise, a treating agent deposited on the surfaces of the inorganic pigment particles means the treating agent is formed directly on the inorganic pigment particles and/or on one or more coatings that are directly or indirectly formed on the inorganic pigment particles.

For example, the inorganic pigment particles can be provided by producing the inorganic pigment as part of the process disclosed herein. Alternatively, the inorganic pigment particles can be provided from a source of an inorganic pigment that has already been produced. For example, one or more bulk containers (e.g., bags) of a pre-existing inorganic pigment can be used as a source of the inorganic pigment.

Examples of inorganic pigments that can be used herein include titanium dioxide, zinc oxide, composite pigments of zinc sulfide and barium sulfate, calcium carbonate, china and kaolin clays, mica, diatomaceous earth, and talc.

For example, the treated, inorganic pigment can be a treated, titanium dioxide pigment, and the inorganic pigment particles used herein can be titanium dioxide pigment particles. The manner in which the titanium dioxide particles are produced, whether as part of the process disclosed herein or otherwise, is not critical. For example, the titanium dioxide particles can be titanium dioxide particles that have been produced by the sulfate process. For example, the titanium dioxide particles can be titanium dioxide particles that have been produced by the chloride process. The particles can have a rutile crystalline structure, an anatase crystalline structure, or a combination thereof. For example, the titanium dioxide particles can have a rutile crystalline structure. For example, the titanium dioxide particles can have an anatase crystalline structure.

In the sulfate process for producing titanium dioxide, a titanium slag ore, usually an ilmenite, is dissolved in sulfuric acid to form titanyl sulfate. The titanyl sulfate is then hydrolyzed to form hydrous titanium dioxide. The hydrated titanium dioxide is heated in a calciner to grow titanium dioxide crystals to pigmentary dimensions.

In the chloride process for producing titanium dioxide, a dry titanium dioxide ore is fed into a chlorinator together with coke and chlorine to produce a gaseous titanium halide (such as titanium tetrachloride). The produced titanium halide is purified and oxidized in a specially designed reactor at a high temperature to produce purified titanium dioxide particles having a desired particle size. Aluminum chloride is typically added to the titanium halide in the oxidation reactor to incorporate alumina into the crystal lattice of the titanium dioxide particles and thereby facilitating rutile formation and control particle size. The titanium dioxide and gaseous reaction products are then cooled and the titanium dioxide particles are recovered.

The titanium dioxide particles can contain alumina as part of their lattice structure. For example, aluminum chloride can be added to the reactants as a rutilization aid during the vapor phase oxidation step of the chloride process. When present during the oxidation reaction, the aluminum chloride imparts alumina into the lattice structure of the pigment.

As used herein and in the appended claims, the term “copolymer” means a polymer derived from more than one type of monomer species. In the copolymerization process, different types of monomer subunits are linked to form a polymer chain. In the case of the PHMS/PDMS copolymer used herein, the PHMS and PDMS are the monomer subunits and are linked together to form the polymer chain.

For example, the PHMS/PDMS copolymer (whether used by itself or in combination with a neat PHMS polymer) includes in the range of from about 20% by weight to about 80% by weight PHMS, and in the range of from about 80% by weight to about 20% by weight PDMS, the weight percentages being based on the total weight of the copolymer. For example, the PHMS/PDMS copolymer includes in the range of from about 30% by weight to about 60% by weight PHMS and in the range of from about 70% by weight to about 40% by weight PDMS, the weight percentages being based on the total weight of the copolymer. For example, in one embodiment, the PHMS/PDMS copolymer includes about 60% by weight PHMS and about 40% by weight PDMS, the weight percentages being based on the total weight of the copolymer.

The PHMS/PDMS copolymer can be a random copolymer, or a block copolymer comprised of PHMS & PDMS units. The PHMS/PDMS copolymer can be linear or branched, and can have an overall molecular weight in the range of from about 2000 to about 20000.

In one embodiment, the organic treating agent is a PHMS/PDMS copolymer. For example, in this embodiment, the PHMS/PDMS copolymer is deposited on the surfaces of the inorganic pigment particles in an amount of at least about 0.5% by weight, based on the weight of the inorganic pigment particles. For example, in this embodiment, the PHMS/PDMS copolymer is deposited on the surfaces of the inorganic pigment particles in an amount in the range of from about 0.5% by weight to about 5% by weight, based on the weight of the inorganic pigment particles. For example, in this embodiment, the PHMS/PDMS copolymer is deposited on the surfaces of the inorganic pigment particles in an amount in the range of from about 1.5% by weight to about 4% by weight, based on the weight of the inorganic pigment particles. For example, in this embodiment, the PHMS/PDMS copolymer is deposited on the surfaces of the inorganic pigment particles in an amount in the range of from about 1.5% by weight to about 3% by weight, based on the weight of the inorganic pigment particles. For example, in this embodiment, the PHMS/PDMS copolymer is deposited on the surfaces of the inorganic pigment particles in an amount in the range of from about 2% by weight to about 3% by weight, based on the weight of the inorganic pigment particles. For example, in this embodiment, the PHMS/PDMS copolymer is deposited on the surfaces of the inorganic pigment particles in an amount of about 2.5% by weight, based on the weight of the inorganic pigment particles. As used herein and the appended claims, “based on the weight of the inorganic pigment particles” means based on the total weight of the raw inorganic pigment particles and all inorganic and organic materials deposited thereon.

For example, as shown by Example 4 below, when the organic treating agent is a PHMS/PDMS copolymer and deposited on the surfaces of the inorganic pigment particles in an amount in the range of from about 1.5% by weight to about 3% by weight, based on the weight of the inorganic pigment particles, the packed bulk density of the treated, inorganic pigment is in the range of from about 0.55 g/cc to about 0.63 g/cc. This is a significant increase in bulk density compared to when the organic treating agent is PHMS alone.

As used herein and in the appended claims, the “packed bulk density” of the treated, inorganic pigment means the bulk density (mass per volume) of the pigment as measured using a Hosokawa Micron powder tester PT-E after the pigment has been poured into a container (for example, a 100 cc beaker) by filling the container with the pigment until the pigment overflows, scraping the excess pigment off the top of the container, and tapping the pigment in the container for 60 cycles in 180 seconds to displace entrained air (as per the Hosakawa method). The “poured bulk density” of the treated, inorganic pigment means the bulk density (mass per volume) of the pigment as measured using a Hosokawa Micron powder tester PT-E after the pigment has been poured into a container (for example, a 100 cc beaker) by filling the container with the pigment until the pigment overflows and scraping the excess pigment off the top of the container thereby creating a relatively loose structure of the pigment in the container (as per the Hosakawa method).

In another embodiment, the organic treating agent is a combination of a PHMS/PDMS copolymer and a neat PHMS polymer. For example, in this embodiment, the PHMS/PDMS copolymer is deposited on the surfaces of the inorganic pigment particles in an amount in the range of from about 0.5% by weight to about 5% by weight, and the neat PHMS polymer is deposited on the surfaces of the inorganic pigment particles in an amount in the range of from about 0.2% by weight to about 4% by weight, the weight percentages being based on the weight of the inorganic pigment particles. For example, in this embodiment, the PHMS/PDMS copolymer is deposited on the surfaces of the inorganic pigment particles in an amount in the range of from about 1.5% by weight to about 4% by weight, and the neat PHMS polymer is deposited on the surfaces of the inorganic pigment particles in an amount in the range of from about 0.5% by weight to about 3% by weight, the weight percentages being based on the weight of the inorganic pigment particles. For example, in this embodiment, the PHMS/PDMS copolymer is deposited on the surfaces of the inorganic pigment particles in an amount in the range of from about 2% by weight to about 3% by weight, and the neat PHMS polymer is deposited on the surfaces of the inorganic pigment particles in an amount in the range of from about 0.2% by weight to about 2% by weight, the weight percentages being based on the weight of the inorganic pigment particles.

The organic treating agent can be deposited on the surfaces of the inorganic pigment particles by any technique for surface treating pigments known in the art. For example, the organic treating agent can be deposited on the surfaces of the pigment particles in a fluid energy mill. The organic treating agent can be mixed with or sprayed on the inorganic pigment when the inorganic pigment is in dry form. The organic treating agent can also be added to a slurry containing the inorganic pigment and dried therewith.

For example, in one embodiment, the process further comprises, prior to depositing the organic treating agent on the surfaces of the inorganic pigment particles, forming a slurry of the inorganic pigment particles, and filtering the inorganic pigment particles to form a filter cake that includes the inorganic pigment particles. The organic treating agent is then deposited on the surfaces of the inorganic pigment particles to form a coating of the organic treating agent thereon by mixing the organic treating agent with the filter cake. For example, by the filtration step, the pigment particles are washed and recovered. The recovered pigment particles can then be dried as part of the pigment finishing process.

For example, in one embodiment, the process further comprises, prior to depositing the organic treating agent on the surfaces of the inorganic pigment particles, depositing an inorganic treating agent on the surfaces of the inorganic pigment particles to form a coating of the inorganic treating agent thereon. For example, the organic treating agent is deposited on top of the coating of the inorganic treating agent to form a coating thereon.

For example, a first inorganic treating agent can be deposited on the surfaces of the inorganic pigment particles to form a coating of the first inorganic treating agent thereon, and a second inorganic treating agent can be deposited on the coating of the first inorganic treating agent to form a coating of the second organic treating agent thereon. A third inorganic treating agent can then be deposited on the coating of the second inorganic treating agent to form a coating of the third inorganic treating agent thereon, and so forth and so on.

For example, when more than one inorganic treating agent are deposited on the surfaces of the inorganic pigment particles to form more than one inorganic treating agent coating thereon, the organic treating agent is deposited on top of all of the coatings of the inorganic treating agents. For example, if the first and second inorganic treating agents are deposited on the pigment, the organic treating agent is then deposited on top of the coating of the second inorganic treating agent. For example, depositing the organic treating agent on top of the coating(s) of the inorganic treating agents (and any other organic materials deposited on the surfaces of the titanium dioxide particles) facilitates and improves the compatibility of the inorganic pigment and inorganic treating agent when the pigment is used in connection with a polymeric resin system.

For example, the inorganic treating agent(s) can be deposited on the surfaces of the inorganic pigment particles by forming an aqueous slurry of the inorganic pigment particles, and precipitating the inorganic treating agent(s) onto the surfaces of the inorganic pigment particles in the slurry to form one or more coating(s) of the inorganic treating agent thereon. Techniques for precipitating one or more inorganic or organic treating agents directly or indirectly on the surfaces of inorganic pigment particles such as titanium dioxide pigment particles in a slurry containing the inorganic pigment particles by successively adding each treating agent to the slurry and adjusting the pH of the slurry as necessary to cause the treating agents to precipitate on the surfaces of the inorganic pigment particles are known in the art. The inorganic and organic treating agent(s) are precipitated onto the inorganic pigment particles in situ in the aqueous slurry.

For example, in order to deposit a metal oxide inorganic treating agent on the surfaces of a plurality of inorganic pigment particles to form a coating thereon, the metal oxide inorganic treating agent can be incrementally added to the aqueous slurry as an aqueous metal oxide salt solution. The pH and temperature of the slurry can be adjusted and maintained at levels that cause precipitation of the specific metal oxide inorganic treating agent to occur. In order to control the pH of the slurry, strong inorganic acids such as hydrochloric acid, nitric acid, sulfuric acid and salts thereof can be used. For example, each separate inorganic treating agent precipitated onto the surfaces of the inorganic pigment particles in the slurry forms a separate coating directly or indirectly on the surfaces of the inorganic pigment particles.

For example, the inorganic treating agent(s) is selected from the group of metal oxide materials and metal hydroxide materials. For example, the inorganic treating agent(s) is selected from the group of silica materials, alumina materials, aluminum phosphate materials, zirconia materials, and titania materials. For example, the inorganic treating agent(s) is selected from the group of silica materials, alumina materials, and zirconia materials. If more than one inorganic treating agent is utilized, the inorganic treating agents can be the same or different.

The inorganic treating agent(s) can be used to impart one or more properties and/or characteristics to the inorganic pigment particles, or enhance the same, to make the particles more suitable for the end-use application, that is, for use in the base composition (for example, the polymer composition) to which the inorganic pigment is to be added and products produced therefrom (for example, plastic articles). For example, silica and/or alumina treating agents can be used to help improve the wetting and dispersing properties of a titanium dioxide pigment as well as the opacity, light stability and durability of the pigment.

For example, the inorganic treating agent(s) can be deposited on the surfaces of the inorganic pigment particles in an amount in the range of about 0.5% by weight to about 15% by weight, based on the weight of the inorganic pigment particles. For example, the inorganic treating agent(s) can be deposited on the surfaces of the inorganic pigment particles in an amount in the range of about 1% by weight to about 10% by weight, based on the weight of the titanium dioxide particles.

For example, in one embodiment, the process disclosed herein is a process for producing a treated, titanium dioxide pigment and comprises the following steps:
(a) providing a plurality of titanium dioxide pigment particles;
(b) after step (a), forming an aqueous slurry of the titanium dioxide pigment particles;
(c) after step (b), reducing the particle size of the titanium dioxide particles in the aqueous slurry to a desired particle size;
(d) after step (c), depositing an inorganic treating agent (or successively depositing more than one inorganic treating agent) onto the surfaces of the titanium dioxide pigment particles to form a coating of the inorganic treating agent thereon (or to form a separate coating for each inorganic treating agent thereon) in the aqueous slurry;
(e) after step (d), filtering the surface treated titanium dioxide pigment particles to form a filter cake that includes the surface treated, titanium dioxide pigment particles;
(f) after step (e), mixing the organic treating agent with the filter cake to deposit the organic treating agent on the coating(s) of the inorganic treating agent(s);
(g) after step (f), drying the filter cake;
(h) after step (g), reducing the particle size of the treated, titanium dioxide particles forming the filter cake to the desired particle size distribution; and
(i) after step (h), packaging the treated, titanium dioxide pigment.

As discussed above, the titanium dioxide pigment particles can be provided in step (a) by producing the titanium dioxide pigment as part of the process disclosed herein. Alternatively, the titanium dioxide pigment particles can be provided in step (a) from a source of titanium dioxide that has already been produced.

A slurry of the titanium dioxide pigment particles can be formed in step (b) by mixing the titanium dioxide particles into an aqueous medium. If necessary or desired, a dispersing agent such as a polyphosphate can be added to the aqueous slurry to facilitate distribution of the titanium dioxide pigment particles therein. For example, the titanium dioxide pigment particles can be added to the aqueous slurry in an amount in the range of from about 5% by weight to about 65% by weight, based on the total weight of the slurry. By way of further example, the titanium dioxide particles are added to the slurry in an amount in the range of from about 15% by weight to about 45% by weight, based on the total weight of the slurry. For example, the titanium dioxide particles are added to the aqueous slurry in an amount in the range of from about 25% by weight to about 40% by weight, based on the total weight of the slurry.

The particle size of the titanium dioxide pigment particles can be reduced in step (c) to a desired particle size by wet milling the pigment particles in the aqueous slurry. For example, the pigment particles in the aqueous slurry can be wet milled to cause at least about 50% of the pigment particles in the slurry to have a particle size of less than 0.5 microns. Various wet milling techniques known in the art can be used to carry out the wet milling step, including cage milling, bead milling, jet milling and sand milling.

The inorganic treating agent(s) can be deposited onto the surfaces of the titanium dioxide pigment particles to form one or more coatings of the inorganic treating agent thereon in the slurry in accordance with step (d) by precipitating the inorganic treating agent(s) onto the surfaces of the titanium dioxide pigment particles as discussed above.

The treated titanium dioxide pigment particles can be filtered to form the filter cake that includes the surface treated titanium dioxide pigment particles in accordance with step (e) by methods known to those skilled in the art. For example, the treated titanium dioxide pigment particles can be recovered by filtration to form a filter cake of the particles and washed using conventional vacuum-type and/or pressure-type filtration systems. The wet treatment deposition of the inorganic treating agent(s) onto the titanium dioxide pigment particles (for example, onto the wet-milled titanium dioxide particles) helps enable the pigment to be recovered and washed using conventional vacuum-type and/or pressure-type filtration systems.

If the organic treating agent is a combination of a PHMS/PDMS copolymer and neat PHMS polymer, the two organic polymers can be mixed with the filter cake in accordance with step separately or as a mixture. The order of addition of the organic polymers is not important.

The filter cake (now treated with one or more inorganic treating agents and the organic treating agent) can be dried in accordance with step (g) by vacuum drying, spin-flash drying, spray drying, oven drying or other techniques known to those skilled in the art to produce a dry inorganic pigment powder. In one embodiment, the filter cake is dried in accordance with step (g) by spray drying the particles.

The particle size of the treated titanium dioxide pigment particles forming the dried filter cake can be reduced to the desired particle size distribution in step (h) by, for example, dry milling the pigment particles. For example, a fluid energy mill can be used to dry mill the pigment particles. Alternatively, the dried pigment particles can be reduced to the desired particle size distribution by steam micronization techniques. As shown by the examples, below, the PHMS/PDMS copolymer organic treating agent can generally withstand the high temperatures and steam associated with steam micronization techniques.

The treated titanium dioxide pigment can then be packaged by any packaging technique known in the art. For example, the dried and milled treated titanium dioxide oxide pigment can be placed in bags and shipped therein.

The treated inorganic pigment provided herein comprises a plurality of inorganic pigment particles, and an organic treating agent deposited on the surfaces of the inorganic pigment particles and forming a coating of the organic treating agent thereon. The organic treating agent is selected from the group consisting of a PHMS/PDMS copolymer, and a combination of a PHMS/PDMS copolymer and a neat PHMS polymer. The PHMS/PDMS copolymer is the PHMS/PDMS copolymer described above in connection with the process disclosed herein.

For example, the treated, inorganic pigment is a treated, titanium dioxide pigment, and the inorganic pigment particles are titanium dioxide particles.

For example, the titanium dioxide particles can be titanium dioxide particles that have been produced by the sulfate process. For example, the titanium dioxide particles can be titanium dioxide particles that have been produced by the chloride process. The titanium dioxide particles can have a rutile crystalline structure, an anatase crystalline structure, or a combination thereof. For example, the titanium dioxide particles can have a rutile crystalline structure. For example, the titanium dioxide particles can have an anatase crystalline structure.

In one embodiment, the organic treating agent is a PHMS/PDMS copolymer. For example, in this embodiment, the PHMS/PDMS copolymer is deposited on the surfaces of the inorganic pigment particles in an amount of at least about 0.5% by weight, based on the weight of the inorganic pigment particles. For example, in this embodiment, the PHMS/PDMS copolymer is deposited on the surfaces of the inorganic pigment particles in an amount in the range of from about 0.5% by weight to about 5% by weight, based on the weight of the inorganic pigment particles. For example, in this embodiment, the PHMS/PDMS copolymer is deposited on the surfaces of the inorganic pigment particles in an amount in the range of from about 1.5% by weight to about 4% by weight, based on the weight of the inorganic pigment particles. For example, in this embodiment, the PHMS/PDMS copolymer is deposited on the surfaces of the inorganic pigment particles in an amount in the range of from about 1.5% by weight to about 3% by weight, based on the weight of the inorganic pigment particles. For example, in this embodiment, the PHMS/PDMS copolymer is deposited on the surfaces of the inorganic pigment particles in an amount in the range of from about 2% by weight to about 3% by weight, based on the weight of the inorganic pigment particles. For example, in this embodiment, the PHMS/PDMS copolymer is deposited on the surfaces of the inorganic pigment particles in an amount of about 2.5% by weight, based on the weight of the inorganic pigment particles.

For example, as shown by Example 4 below, when the organic treating agent is a PHMS/PDMS copolymer and deposited on the surfaces of the inorganic pigment particles in an amount in the range of from about 1.5% by weight to about 3% by weight, based on the weight of the inorganic pigment particles, the packed bulk density of the treated, inorganic pigment is in the range of from about 0.55 g/cc to about 0.63 g/cc. Again, this is a significant increase in bulk density compared to when the organic treating agent is PHMS alone.

In another embodiment, the organic treating agent is a combination of a PHMS/PDMS copolymer and a neat PHMS polymer. For example, in this embodiment, the PHMS/PDMS copolymer is deposited on the surfaces of the inorganic pigment particles in an amount in the range of from about 0.5% by weight to about 5% by weight, and the neat PHMS polymer is deposited on the surfaces of the inorganic pigment particles in an amount in the range of from about 0.2% by weight to about 4% by weight, the weight percentages being based on the weight of the inorganic pigment particles. For example, in this embodiment, the PHMS/PDMS copolymer is deposited on the surfaces of the inorganic pigment particles in an amount in the range of from about 1.5% by weight to about 4% by weight, and the neat PHMS polymer is deposited on the surfaces of the inorganic pigment particles in an amount in the range of from about 0.5% by weight to about 3% by weight, the weight percentages being based on the weight of the inorganic pigment particles. For example, in this embodiment, the PHMS/PDMS copolymer is deposited on the surfaces of the inorganic pigment particles in an amount in the range of from about 2% by weight to about 3% by weight, and the neat PHMS polymer is deposited on the surfaces of the inorganic pigment particles in an amount in the range of from about 0.2% by weight to about 2% by weight, the weight percentages being based on the weight of the inorganic pigment particles.

In one embodiment, the treated inorganic pigment further comprises an inorganic treating agent deposited on the surfaces of the inorganic pigment particles and forming a coating of the inorganic treating agent thereon. For example, the organic treating agent can be deposited on top of the coating of the inorganic treating agent.

For example, a first inorganic treating agent can be deposited on the surfaces of the inorganic pigment particles to form a coating of the first inorganic treating agent thereon, and a second inorganic treating agent can be deposited on top of the coating of the first inorganic treating agent to form a coating of the second inorganic treating agent thereon. For example, the organic treating agent can be deposited on top of the coating of the second inorganic treating agent.

The inorganic treating agent(s) can be the inorganic treating agent(s) described above in connection with the process disclosed herein. For example, the inorganic treating agent(s) is deposited on the surfaces of the inorganic pigment particles in an amount in the range of about 0.5% by weight to about 15% by weight, based on the combined weight of the inorganic pigment particles and the inorganic coating(s). For example, the inorganic treating agent(s) is deposited on the surfaces of the inorganic pigment particles in an amount in the range of about 1% by weight to about 10% by weight, based on the weight of the inorganic pigment particles.

The treated inorganic pigment can be formed by the process disclosed herein.

In one embodiment, the process provided herein is a process for producing a treated, titanium dioxide pigment. The process comprises providing a plurality of titanium dioxide pigment particles, and depositing an organic treating agent on the surfaces of the pigment particles to form at least one coating of the organic treating agent thereon. The organic treating agent is selected from the group consisting of a PHMS/PDMS copolymer, and a combination of a PHMS/PDMS copolymer and a neat PHMS polymer.

In another embodiment, the process provided herein is also a process for producing a treated, titanium dioxide pigment. The process comprises providing a plurality of titanium dioxide pigment particles, and depositing an organic treating agent on the surfaces of the pigment particles to form at least one coating of the organic treating agent thereon. The organic treating agent is selected from the group consisting of a PHMS/PDMS copolymer, and a combination of a PHMS/PDMS copolymer and a neat PHMS polymer, wherein the PHMS/PDMS copolymer includes in the range of from about 20% by weight to about 80% by weight PHMS, and in the range of from about 80% by weight to about 20% by weight PDMS, the weight percentages being based on the total weight of the copolymer.

In another embodiment, the process provided herein is also a process for producing a treated, titanium dioxide pigment. The process comprises providing a plurality of titanium dioxide pigment particles, forming a slurry of the inorganic pigment particles, filtering the inorganic pigment particles to form a filter cake that includes the inorganic pigment particles, and depositing an organic treating agent on the surfaces of the pigment particles to form at least one coating of the organic treating agent thereon by mixing the organic treating agent with the filter cake, wherein the organic treating agent is selected from the group consisting of a PHMS/PDMS copolymer, and a combination of a PHMS/PDMS copolymer and a neat PHMS polymer.

In one embodiment, the treated, inorganic pigment provided herein is a treated, titanium dioxide pigment. The pigment comprises a plurality of titanium dioxide pigment particles, and an organic treating agent deposited on the surfaces of the pigment particles and forming at least one coating of the organic treating agent thereon, wherein the organic treating agent is selected from the group consisting of a PHMS/PDMS copolymer, and a combination of a PHMS/PDMS copolymer and a neat PHMS polymer.

In another embodiment, the treated, inorganic pigment provided herein is also a treated, titanium dioxide pigment. The pigment comprises a plurality of titanium dioxide pigment particles, and an organic treating agent deposited on the surfaces of the pigment particles and forming at least one coating of the organic treating agent thereon. The organic treating agent is selected from the group consisting of a PHMS/PDMS copolymer, and a combination of a PHMS/PDMS copolymer and a neat PHMS polymer, wherein the PHMS/PDMS copolymer includes in the range of from about 20% by weight to about 80% by weight PHMS, and in the range of from about 80% by weight to about 20% by weight PDMS, the weight percentages being based on the total weight of the copolymer.

In another embodiment, the treated, inorganic pigment provided herein is also a treated, titanium dioxide pigment. The pigment comprises a plurality of titanium dioxide pigment particles, and an organic treating agent deposited on the surfaces of the pigment particles and forming at least one coating of the organic treating agent thereon. The organic treating agent is a PHMS/PDMS copolymer, wherein the PHMS/PDMS copolymer includes in the range of from about 20% by weight to about 80% by weight PHMS, and in the range of from about 80% by weight to about 20% by weight PDMS, the weight percentages being based on the total weight of the copolymer, and wherein the PHMS/PDMS copolymer is deposited on the surfaces of the inorganic pigment particles in an amount in the range of from about 0.5% by weight to about 5% by weight, based on the combined weight of the inorganic pigment particles and the organic treating agent.

In another embodiment, the treated, inorganic pigment provided herein is also a treated, titanium dioxide pigment. The pigment comprises a plurality of titanium dioxide pigment particles, and an organic treating agent deposited on the surfaces of the pigment particles and forming at least one coating of the organic treating agent thereon. The organic treating agent is a combination of a PHMS/PDMS copolymer and a neat PHMS polymer, wherein the PHMS/PDMS copolymer includes in the range of from about 20% by weight to about 80% by weight PHMS, and in the range of from about 80% by weight to about 20% by weight PDMS, the weight percentages being based on the total weight of the copolymer, and wherein the PHMS/PDMS copolymer is deposited on the surfaces of the inorganic pigment particles in an amount in the range of from about 0.5% by weight to about 5% by weight, and the net PHMS polymer is deposited on the surfaces of the inorganic pigment particles in an amount in the range of from about 0.2% by weight to about 4% by weight, the weight percentages being based on the combined weight of the inorganic pigment particles and the organic treating agent.

The organic treating agent herein, whether a PHMS/PDMS copolymer by itself or a PHMS/PDMS copolymer in combination with a neat PHMS polymer, is relatively stable in high temperature environments (for example, up to 250° C. resulting in minimal loss of the treating agent during subsequent finishing and processing of the pigment. The reactivity of the PHMS in the copolymer and in connection with the neat PHMS polymer is significantly reduced when compared to the reactivity of PHMS when used alone. Thus, the issue of loss of PHMS during high temperature processing of the pigment (for example, when PHMS is used alone) is addressed. Hydrogen evolution is minimized. Surprisingly, as shown by the examples below, titanium dioxide pigments surface treated with the organic treating agent disclosed herein perform better than titanium dioxide pigments treated with a simple blend of PHMS and PDMS.

PDMS does not react with pigment surface. On the other hand, PHMS, due to its reactive hydrogen, reacts with pigment surface. In case of a PHMS and PDMS blend, two separate layers are formed. In the case of the PHMS/PDMS copolymer, due to molecular level distribution of PHMS and PDMS, the copolymer is uniformly coated on the pigment as a single layer.

The treated titanium dioxide pigment produced in accordance the process herein is very suitable for use in polymer compositions. As used herein and in the appended claims, a “polymer composition” means a composition containing a polymer as one of the components thereof. For example, the polymer composition can be a polymer masterbatch composition suitable for use in forming various polymer and plastic products. Examples of polymer compositions in which the treated titanium dioxide pigment disclosed herein can be used include polyolefin polymer compositions, polyvinyl chloride polymer compositions and polycarbonate (engineering plastics) compositions. The treated titanium dioxide pigment disclosed herein can enhance pigment/polymer compatibility and decrease thermoplastic polymer melt viscosity, thereby helping to enhance thermoplastic stability, optimize thermoplastic surface aesthetics, and improve overall processing of the polymer composition.

The treated titanium dioxide pigment produced herein is very suitable for use in connection with polycarbonate compositions. The pigments have good rheological properties and other performance characteristics in polycarbonate compositions and articles.

### ILLUSTRATIVE EXAMPLES

The treated inorganic pigment formed by the process disclosed herein and the treated inorganic pigment disclosed herein are exemplified by the following examples.

### Example 1

### Thermogravimetric (TGA) Studies on Polymers

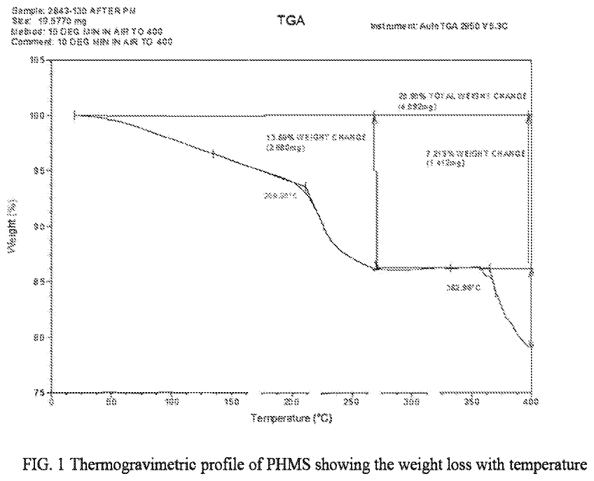

Samples of a PHMS polymer, a PDMS polymer, and a PHMS-PDMS copolymer were subjected to TGA studies using a Universal thermal analysis (TA) instrument. In carrying out the tests, 10-25 mg polymer sample sizes and at a ramp rate of 10°/min in air were utilized. The weight loss of each polymer sample over time as the temperature increased was analyzed. TGA profiles of the samples are presented in FIGS. 1-4 of the drawings.

FIG. 1 shows the TGA profile of the PHMS polymer. As shown, the PHMS polymer started losing weight starting at about 50° C., and significant weight loss was incurred at around 270° C.

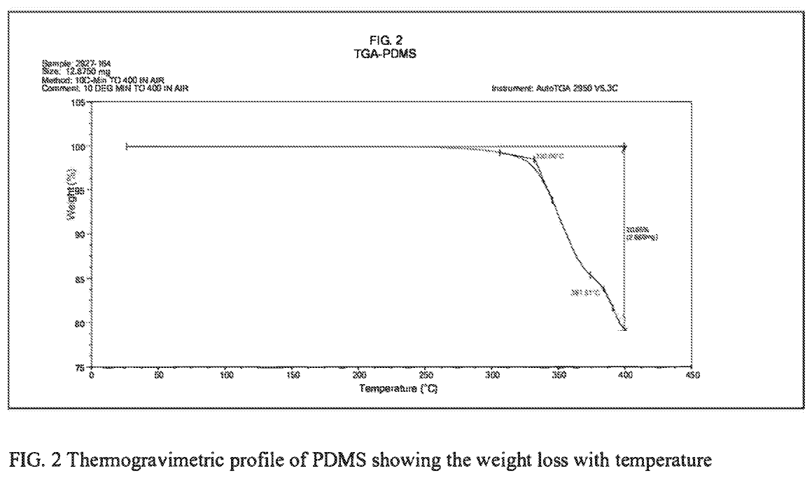

FIG. 2 shows the TGA profile of the PDMS polymer. As shown, the PDMS polymer started losing weight starting at about 330° C., and was fairly stable compared to neat PHMS.

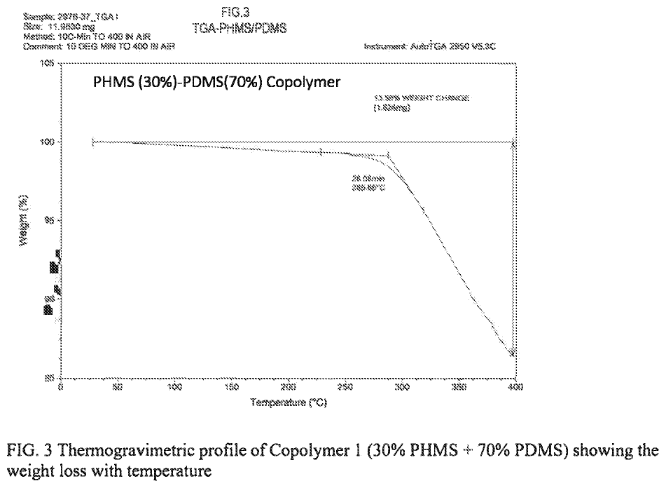

FIG. 3 shows the TGA profile of a PHMS/PDMS copolymer consisting of 30% by weight PHMS and 70% by weight PDMS (Copolymer 1 in Example 3C below). As shown, the copolymer started losing weight around 286° C.

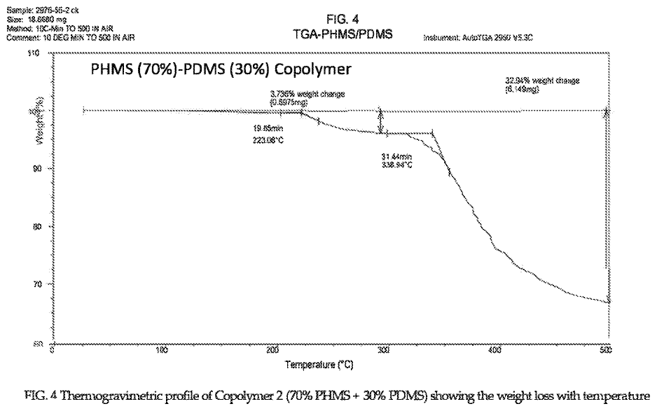

FIG. 4 shows the TGA profile of a PHMS/PDMS copolymer consisting of 70% by weight PHMS and 30% by weight PDMS (Copolymer 2 in Example 3C below). As shown, the copolymer started losing weight around 223° C., more significantly at 250° C.

These studies demonstrated that the various polymers and copolymers behave differently in water as the temperature increases. For example, the weight loss experienced by each polymer at approximately 250° C. is significant. Once an inorganic pigment such as titanium dioxide is coated with an organic polymer, temperatures up to 250° C. can be encountered in subsequent pigment finishing steps.

### Example 2

### Hydrogen Evolution Studies on Polymers in TiO2 Slurry

Next, hydrogen evolution studies were carried out on PHMS polymer and PHMS/PDMS copolymer samples. In each test, an aqueous slurry containing 50% by weight of a titanium dioxide pigment was prepared. The pigment slurry and polymer or copolymer being tested was then thoroughly mixed in a closed vessel and heat treated at various temperatures with an equilibrium time of approximately one minute at each temperature. The test mixture was eventually heated to 280° C., and then equilibrated for approximately 3 minutes.

In each test, the amount of evolved hydrogen was determined by gas chromatography using HP5890II GC-TCD gas chromatography equipment with a packed Carboxen 1000 column. The results are presented in Table 1 below:

TABLE 1
Hydrogen evolution data on neat PHMS and PHMS-PDMS copolymers at various temperatures when mixed with TiO₂ slurry

| 20210128-01 | 2.2% PHMS | 20210128-02 | 2.26% Copolymer 1 | 20210128-04 | 2.26% Copolymer 2 |
|---|---|---|---|---|---|
| TiO2 Slurry wt. (g) | 5.003 | TiO2 Slurry wt. (g) | 5.035 | TiO2 Slurry wt. (g) | 5.118 |
| PHMS wt. (mg) | 56 | PHMS Copolymer wt. (mg) | 57 | PHMS Copolymer wt. (mg) | 58 |
| | | PDMS(70%) & PHMS (30%) | | PDMS(30%) & PHMS (70%) | |

| Temp C. | H2, mL | Temp C. | H2, mL | Temp C. | H2, mL |
|---|---|---|---|---|---|
| 22 | <0.2 | 22 | <0.2 | 21 | <0.2 |
| 65 | <0.2 | 65 | <0.2 | 60 | <0.2 |
| 100 | <0.2 | 100 | <0.2 | 100 | <0.2 |
| 160 | 0.3 | 160 | <0.2 | 150 | <0.2 |
| 210 | 1.5 | 205 | 0.4 | 200 | 0.4 |
| 240 | 6.8 | 240 | 0.9 | 240 | 1.4 |
| 280 | 7.8 | 280 | 1.1 | 280 | 2.1 |
| % of H2 | 74 | | 40 | | 30 |
| Evolution | | | | | |

As shown for PHMS, evolution of the hydrogen started at around 200° C. and increased significantly at 240° C. For the PHMS-PDMS copolymers, evolution of hydrogen started to some extent at 280° C. At 280° C., after equilibrating the samples for 3 minutes, the total percentage of hydrogen evolved was calculated based on the theoretical value of the total hydrogen of the polymer. Both copolymers showed lower hydrogen evolution than the neat PHMS sample.

### Example 3

### Performance of Siloxane Treated TiO2 Pigments in Polycarbonate Resin Composition

A series of polycarbonate resin test samples was prepared by treating portions of a raw titanium dioxide pigment sample with varying amounts of PHMS, a blend of PHMS and PDMS and a PHMS/PDMS copolymer to form corresponding treated pigment samples and combining the treated pigment samples with an amount of a polycarbonate resin. Tests were then carried out on the polycarbonate resin test samples to evaluate the performance of the treated pigment samples therein, specifically the impact of the treated pigment on the thermal stability of the resin. These tests are described in Examples 3A, 3B and 3C below.

In preparing the treated pigment samples used in the tests, an aqueous inorganic pigment slurry containing 50% by weight solids based on the total weight of the slurry was first prepared. The inorganic pigment used was raw titanium dioxide that had been prepared by the chloride process and contained 0.8% alumina in its crystalline lattice. The pigment was dispersed in water in the presence of 0.1% by weight (based on the pigment) of sodium hexametaphosphate dispersant and an amount of sodium hydroxide sufficient to adjust the pH of the dispersion to a minimum value of 9.5 to provide an aqueous raw pigment slurry having a solids content of 35% by weight.

The raw pigment slurry was then subjected to sand milling using a zircon sand-to-pigment weight ratio of 4 to 1 until a volume average particle size was achieved wherein greater than 90% of the particles were smaller than 0.63 microns, as determined utilizing a Microtrac X100 Particle Size Analyzer (Microtrac Inc. of Montgomeryville, PA). The slurry was then heated to 75° C., acidified to a pH of 2.0 using concentrated sulfuric acid, and allowed to digest at 75° C. for 30 minutes. After the initial digestion period, the pH of the slurry was adjusted to a value of 6.5 using a 20% by weight aqueous sodium hydroxide solution and then allowed to digest for an additional 30 minutes at 75° C. Following this digestion period, the pH was readjusted to 6.5, as necessary, and then filtered while hot. The resulting raw, titanium dioxide filter cake was washed with an amount of preheated water (preheated to 60° C.) equal to the weight of recovered pigment.

### Example 3A

### PHMS

A first series of treated pigment test samples was prepared by adding various amounts of PHMS to a portion of the washed, raw titanium dioxide pigment filter cake prepared as discussed above. The amounts of PHMS used to form the treated pigment test samples were 2%, 2.5%, 3%, and 3.75%, each being the percent by weight based on the weight of the filter cake (??). In preparing each treated pigment test sample, the PHMS was added to a portion of the filter cake and mixed therewith in the desired amount, thereby causing the PHMS to be deposited on the surfaces of the pigment particles and form a coating thereon.

Each treated pigment test sample was then oven dried at 110° C. overnight. The dried pigment was crushed to yield a dry treated pigment powder. The dry treated pigment powder was then steam micronized utilizing a steam to pigment weight ratio of 1.8, with a steam injector pressure set at 160 psi and micronizer ring pressure set at 120 psi.

Each treated pigment test sample was then added to an amount of polycarbonate resin to form a corresponding polycarbonate resin test sample. The resin used to prepare the polycarbonate resin test samples was a Makrolon 3108 polycarbonate resin that had been dried for 3 hours at 125° C. The polycarbonate resin test samples were prepared by loading a portion of the resin with 5% by weight of the treated pigment, based on the weight of the resin, using a Leistritz twin screw extruder with a strand die attachment. The temperature in zone 1 was 230° C. The temperature in zones 2-6 was 280° C. The die temperature was 280° C. The average screw speed was 50 rpm.

The resulting polycarbonate concentrate strands forming each polycarbonate resin test sample were then cooled using a water trough, chipped using a chipper, and dried in an oven at 125° C. for 3 hours. The concentrates were then injection molded using a BOY injection molding machine to form corresponding polycarbonate test articles. The baseline condition was 300° C. for 1.75 minutes. The higher temperature condition was 360° C. for 1.75 minutes. The color difference between the two conditions for each sample was then evaluated. The results are presented in Table 2 below:

TABLE 2
Thermal stability data of Polycarbonate Resin Test Samples made
with TiO₂ coated with various amounts of PHMS (??)

| 95% Makrolon 3108 Color Chip | | 300° C. | | | 360° C. | | | |
|---|---|---|---|---|---|---|---|---|
| Description | | L* | a* | b* | L* | a* | b* | Δb |
| 2% | PHMS | 95.63 | −0.36 | 2.73 | 95.24 | −0.40 | 3.23 | 0.5 |
| 2.5% | PHMS | 96.02 | −0.47 | 2.59 | 95.56 | −0.42 | 2.99 | 0.4 |
| 3% | PHMS | 95.81 | −0.46 | 2.35 | 95.44 | −0.45 | 2.68 | 0.33 |
| 3.75% | PHMS | 96.33 | −0.54 | 1.95 | 96.04 | −0.58 | 2.23 | 0.28 |

The results show that as the PHMS levels are increased, the b* value becomes lower and the Δb values also decrease, which shows good thermal stability of the polycarbonate plaques. Thus, PHMS-treated titanium dioxide pigment effectively performs in a polycarbonate polymer.

### Example 3B

### PHMS and PDMS Blend

Next, a second series of treated pigment test samples was prepared as discussed in Example 3A, except that in two of the test samples, instead of just PHMS, a blend of the desired amount of PHMS and 1% by weight PDMS, based on the total weight of the PHMS AND PDMS, were added to the washed, raw titanium dioxide pigment filter cake and mixed therewith. The amounts of PHMS and total amount of PHMS and PDMS used to form the treated pigment test samples were 3.75% (PHMS), 3% (PHMS), 3.75% (PHMS and PDMS), and 2.75% (PHMS and PDMS), each being the percent by weight based on the weight of the filter cake (??). The PHMS and PDMS blend was deposited on the surfaces of the pigment particles and formed one or more coatings thereon. Each treated pigment test sample was then dried and steam micronized, and combined with an amount of a polycarbonate resin to form a corresponding polycarbonate resin test sample, as described in Example 3A. The resulting polycarbonate concentrate strands forming each polycarbonate resin test sample were then processed and tested as described in Example 3A. The results are presented in Table 3 below.

TABLE 3
Thermal stability data of Polycarbonate Resin Test Samples made with
TiO₂ coated with various amounts of PHMS and PHMS and 1% PDMS

| 95% Makrolon 3108 Color Chip | 300° C. | | | 360° C. | | | |
|---|---|---|---|---|---|---|---|
| Description | L* | a* | b* | L* | a* | b* | Δb |
| 3.75% PHMS | 96.33 | −0.54 | 1.95 | 96.04 | −0.58 | 2.23 | 0.28 |
| 3% PHMS | 95.81 | −0.46 | 2.35 | 95.44 | −0.45 | 2.68 | 0.33 |
| 2.75% PHMS + 1% PDMS | 95.53 | −0.47 | 2.47 | 95.11 | −0.36 | 2.94 | 0.47 |
| 1.75% PHMS + 1% PDMS | 95.58 | −0.33 | 2.88 | 95.12 | −0.38 | 3.46 | 0.58 |

The results show that the addition of PDMS to the PHMS to form a simple blend of PHMS and PDMS did not improve the thermal stability. In fact, the addition of PDMS to PHMS to form a simple blend of PHMS and PDMS caused the thermal stability of the polycarbonate plaques to slightly deteriorate. Thus, the results confirm that the combination of PHMS and PDMS to form a simple polymer blend did not achieve a synergistic effect between the PHMS and PDMS.

### Example 3C

### PHMS and PHMS/PDMS Copolymers

Finally, a third series of treated pigment test samples was prepared as discussed in Example 3A, except that in all but two of the test samples, instead of just PHMS, a PHMS/PDMS copolymer was added to the washed, raw titanium dioxide pigment filter cake and mixed therewith. Treated pigment test samples were formed using two different PHMS/PDMS copolymers were tested, a first PHMS/PDMS copolymer formed of 30% by weight PHMS and 70% by weight PDMS (based on the total weight of the copolymer (“Copolymer 1”), and a second PHMS/PDMS copolymer formed of 70% by weight PHMS and 30% by weight PDMS (based on the total weight of the copolymer (“Copolymer 2”). Also, treated pigment test samples were formed using various amounts of PHMS and Copolymer 1.

First, polycarbonate resin test samples formed with treated pigment test samples including PHMS, Copolymer 1 and Copolymer 1 together with PHMS were tested. The amounts of PHMS, Copolymer 1 and Copolymer 1 and PHMS are shown in Table 4 below. Each percentage shown in Table 4 represents the percent by weight based on the weight of the filter cake. The various polymers and/or copolymers were deposited on the surfaces of the pigment particles and formed one or more coatings thereon. For example, separate coatings can be formed, or the PHMS and PHMS-PDMS copolymer can be randomly distributed on the pigment surface.

Each treated pigment test sample was then dried and steam micronized, and combined with an amount of a polycarbonate resin to form a corresponding polycarbonate resin test sample, as described in Example 3A. The resulting polycarbonate concentrate strands forming each polycarbonate resin test sample were then processed and tested as described in Example 3A. The results are presented in Table 4 below.

TABLE 4
Thermal stability data of Polycarbonate Resin Test Samples made with TiO₂ coated
with various amounts of copolymer 1 (30% PHMS + 70% PDMS) and PHMS combinations

| | % PHMS | | | | | | | |
|---|---|---|---|---|---|---|---|---|
| 95% Makrolon 3108 Color Chip | content | 300° C. | | | 360° C. | | | |
| Description | in the sample | L* | a* | b* | L* | a* | b* | Δb |
| 3% PHMS | 3.00 | 95.36 | −0.34 | 2.43 | 95.13 | −0.33 | 2.86 | 0.43 |
| 2.5% PHMS | 2.50 | 95.59 | −0.42 | 2.51 | 95.23 | −0.45 | 2.98 | 0.47 |
| 2% Copolymer 1 | 0.6 | 95.28 | −0.42 | 2.95 | 95.01 | −0.40 | 3.54 | 0.59 |
| 2.5% Copolymer 1 | 0.75 | 95.88 | −0.48 | 2.54 | 95.68 | −0.48 | 2.89 | 0.35 |
| 3% Copolymer 1 | 0.90 | 95.96 | −0.50 | 2.42 | 95.81 | −0.51 | 2.61 | 0.19 |
| 1.5% Copolymer 1 + 0.5% PHMS | 0.95 | 95.50 | −0.43 | 2.48 | 95.22 | −0.43 | 2.90 | 0.42 |
| 1% Copolymer 1 + 1% PHMS | 1.3 | 95.51 | −0.43 | 2.39 | 95.10 | −0.42 | 2.86 | 0.47 |
| 1.5% Copolymer I + 1% PHMS | 1.45 | 95.45 | −0.44 | 2.45 | 95.14 | −0.44 | 2.97 | 0.52 |
| 2% Copolymer 1 + 0.5% PHMS | 1.1 | 95.72 | −0.42 | 2.27 | 95.52 | −0.43 | 2.57 | 0.3 |
| 2.5% Copolymer 1 + 0.5% PHMS | 1.25 | 95.83 | −0.44 | 2.21 | 95.63 | −0.45 | 2.51 | 0.3 |

The results shown in Table 4 demonstrate that the test samples that include Copolymer 1 demonstrate much better thermal stability as compared to the samples containing only PHMS. The one exception is the test sample including only 2% of Copolymer 1. For example, the test sample prepared with 2.5% of just Copolymer 1 performed better than the test sample formed with 2.5% of just PHMS. As shown by Examples 1 and 2, the weight loss is minimum and hydrogen liberation is much less with the test sample formed with 2.5% of Copolymer as compared to a test sample formed with 2.5% of just PHMS. Similarly, the combination of Copolymer 1 with just 0.5% PHMS showed improved thermal stability and less weight loss and hydrogen evolution, further demonstrating the synergistic effect of PHMS/PDMS copolymers.

### Example 3D

Next, polycarbonate resin test samples formed with treated pigment test samples including Copolymer 2 and Copolymer 2 together with PHMS were tested. The amounts of Copolymer 2 and Copolymer 2 are shown in Table 5 below. Each percentage shown in Table 5 represents the percent by weight based on the weight of the filter cake. The various polymers and/or copolymers were deposited on the surfaces of the pigment particles and formed one or more coatings thereon. For example, separate coatings can be formed, or the PHMS and PHMS-PDMS copolymer can be randomly distributed on the pigment surface.

Each treated pigment test sample was then dried and steam micronized, and combined with an amount of a polycarbonate resin to form a corresponding polycarbonate resin test sample, as described in Example 3A. The resulting polycarbonate concentrate strands forming each polycarbonate resin test sample were then processed and tested as described in Example 3A. The results are presented in Table 5 below.

TABLE 5
Thermal stability data of Polycarbonate Resin Test Samples made with TiO₂ coated
with various amounts of Copolymer 2 (70% PHMS + 30% PDMS) and PHMS combinations

| 95% Makrolon 3108 Color Chip | | 300° C. | | | 360° C. | | | |
|---|---|---|---|---|---|---|---|---|
| Description | % PHMS | L* | a* | b* | L* | a* | b* | Δb |
| 1.5% Copolymer 2 + 0.2% PHMS | 1.25 | 95.45 | −0.35 | 2.38 | 95.03 | −0.36 | 2.85 | 0.47 |
| 1.5% Copolymer 2 + 0.5% PHMS | 1.55 | 95.26 | −0.34 | 2.16 | 94.98 | −0.38 | 2.59 | 0.43 |
| 2% Copolymer 2 | 1.4 | 95.51 | −0.35 | 2.22 | 94.95 | −0.37 | 2.70 | 0.48 |
| 2% Copolymer 2 + 0.2% PHMS | 1.6 | 95.55 | −0.34 | 1.99 | 95.25 | −0.37 | 2.42 | 0.43 |

The results shown in Table 5 confirm that test samples prepared Copolymer 2 perform much better than test samples formed with just neat PHMS and suffer less weight loss.

### Example 4

Next, treated pigment test samples formed with various amounts of Copolymer 1 as described above and a treated pigment test sample formed in the same way with just PHMS were tested to determine the packed bulk density and poured bulk density thereof.

The bulk density values of the pigments were measured using a standard Hosokawa Micron powder tester PT-E. The results are shown in Table 6 below.

TABLE 6
Comparison of Bulk Density of the pigment made with
various levels of PHMS-PDMS Copolymer and Neat PHMS

| | Packed | Poured |
|---|---|---|
| Polymer | density (g/cc) | density (g/cc) |
| 1.5% Copolymer 1 | 0.552 | 0.313 |
| 2.0% Copolymer 1 | 0.570 | 0.318 |
| 2.5% Copolymer 1 | 0.585 | 0.321 |
| 3% Copolymer 1 | 0.624 | 0.336 |
| 1.5% PHMS | 0.503 | 0.301 |
| 2.0% PHMS | 0.519 | 0.307 |
| 2.5% PHMS | 0.522 | 0.315 |
| 3.0% PHMS | 0.538 | 0.324 |

The results show that a significant increase in the bulk density (both packed and poured) of the pigment sample was observed when a PHMS/PDMS copolymer was used as an organic treating agent as compared to when a PHMS polymer alone was used as an organic treating agent.

Thus, the pigments, compositions and methods are well adapted to attain the ends and advantages mentioned, as well as those that are inherent therein. The particular examples disclosed above are illustrative only, as the present pigments, compositions and methods may be modified and practiced in different but equivalent manners apparent to those skilled in the art having the benefit of the teachings herein. It is therefore evident that the particular illustrative examples disclosed above may be altered or modified, and all such variations are considered within the scope and spirit of the present pigments, compositions and methods. While the pigments, compositions and methods are described in terms of “comprising,” “containing,” “having,” or “including” various components or steps, the pigments, compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A process for producing a treated, inorganic pigment, comprising:
providing a plurality of inorganic pigment particles; and
depositing an organic treating agent on the surfaces of said pigment particles to form at least one coating of said organic treating agent thereon, wherein said organic treating agent is selected from the group consisting of PHMS/PDMS copolymer, and a combination of a PHMS/PDMS copolymer and a neat PHMS polymer.

2. The process of claim 1, wherein said inorganic pigment particles are provided by producing the pigment particles as part of the process.

3. The process of claim 1, wherein said treated, inorganic pigment is a treated, titanium dioxide pigment, and said inorganic pigment particles are titanium dioxide pigment particles.

4. The process of claim 3, wherein said titanium dioxide particles are titanium dioxide particles that have been produced by the sulfate process.

5. The process of claim 3, wherein said titanium dioxide particles are titanium dioxide particles that have been produced by the chloride process.

6. The process of claim 1, wherein said PHMS/PDMS copolymer includes in the range of from about 20% by weight to about 80% by weight PHMS, and in the range of from about 80% by weight to about 20% by weight PDMS, said weight percentages being based on the total weight of said copolymer.

7. The process of claim 1, wherein said organic treating agent is a PHMS/PDMS copolymer.

8. The process of claim 7, wherein said PHMS/PDMS copolymer is deposited on said surfaces of said inorganic pigment particles in an amount of at least about 0.5% by weight, based weight of said inorganic pigment particles.

9. The process of claim 7, wherein said PHMS/PDMS copolymer is deposited on said surfaces of said inorganic pigment particles in an amount in the range of from about 2% by weight to about 3% by weight, based on the weight of the inorganic pigment particles, and the packed bulk density of the treated, inorganic pigment is in the range of from about 0.55 g/cc to about 0.63 g/cc.

10. The process of claim 1, wherein said organic treating agent is a combination of a PHMS/PDMS copolymer and a neat PHMS polymer.

11. The process of claim 10, wherein said PHMS/PDMS copolymer is deposited on said surfaces of said inorganic pigment particles in an amount in the range of from about 0.5% by weight to about 5% by weight, and said net PHMS polymer is deposited on the surfaces of said inorganic pigment particles in an amount in the range of from about 0.2% by weight to about 4% by weight, said weigh percentages being based on the combined weight of said inorganic pigment particles and said organic treating agent.

12. The process of claim 1, further comprising:
prior to depositing said organic treating agent on said surfaces of said inorganic pigment particles:
forming a slurry of said inorganic pigment particles; and
filtering said inorganic pigment particles to form a filter cake that includes said inorganic pigment particles, wherein said organic treating agent is deposited on said surfaces of said inorganic pigment particles to form at least one coating of said organic treating agent thereon by mixing said organic treating agent with said filter cake.

13. The process of claim 1, further comprising:
prior to depositing said organic treating agent on said surfaces of said inorganic pigment particles:
depositing an inorganic treating agent on the surfaces of said inorganic pigment particles to form a coating of said inorganic treating agent thereon.

14. The process of claim 13, wherein said organic treating agent is deposited on top of said coating of said inorganic treating agent to form a coating thereon.

15. The process of claim 13, wherein said inorganic treating agent is selected from the group of metal oxide materials and metal hydroxide materials.

16. A process for producing a treated, titanium dioxide pigment, comprising:
providing a plurality of titanium dioxide pigment particles;
depositing an inorganic treating agent on the surfaces of said titanium dioxide pigment particles to form a coating of said organic treating agent thereon;
depositing an organic treating agent on top of said coating of said inorganic treating agent to form at least one coating of said organic treating agent thereon, wherein said organic treating agent is selected from the group consisting of a PHMS/PDMS copolymer, and a combination of a PHMS/PDMS copolymer and a neat PHMS polymer.

17. The process of claim 16, wherein said organic treating agent is a PHMS/PDMS copolymer.

18. The process of claim 16, wherein said organic treating agent is a combination of a PHMS/PDMS copolymer and a neat PHMS polymer.

19. The process of claim 16, further comprising:
prior to depositing said organic treating agent on said coating of said inorganic treating agent:
forming a slurry of said titanium dioxide pigment particles, wherein said inorganic treating agent is deposited on said surfaces of said titanium dioxide pigment particles to form a coating of said inorganic treating agent thereon by precipitating said inorganic treating agent on said titanium dioxide pigment particles in said slurry; and
filtering said slurry to form a filter cake that includes said surface treated titanium dioxide pigment particles, wherein said organic treating agent is deposited on said coating of said inorganic treating agent to form at least one coating of said organic treating agent thereon by mixing said organic treating agent with said filter cake.

20. A treated, inorganic pigment, comprising:
a plurality of inorganic pigment particles; and
an organic treating agent deposited on the surfaces of said inorganic pigment particles and forming at least one coating of said organic treating agent thereon, wherein said organic treating agent is selected from the group consisting of a PHMS/PDMS copolymer, and a combination of a PHMS/PDMS copolymer and a neat PHMS polymer.

21. The pigment of claim 20, wherein said treated, inorganic pigment is a treated, titanium dioxide pigment, and said inorganic pigment particles are titanium dioxide pigment particles.

22. The pigment of claim 20, wherein said PHMS/PDMS copolymer includes in the range of from about 20% by weight to about 80% by weight PHMS and in the range of from about 80% by weight to about 20% by weight PDMS, said weight percentages being based on the total weight of said copolymer.

23. The pigment of claim 20, wherein said organic treating agent is a PHMS/PDMS copolymer.

24. The pigment of claim 23, wherein said PHMS/PDMS copolymer is deposited on said surfaces of said inorganic pigment particles in an amount in the range of from about 0.5% by weight to about 5% by weight, based on the combined weight of said inorganic pigment particles and said organic treating agent.

25. The pigment of claim 23, wherein said PHMS/PDMS copolymer is deposited on said surfaces of said inorganic pigment particles in an amount in the range of from about 1.5% by weight to about 3% by weight, and said packed bulk density of said treated, inorganic pigment is in the range of from about 0.55 g/cc to about 0.63 g/cc.

26. The pigment of claim 20, wherein said organic treating agent is a combination of a PHMS/PDMS copolymer and a neat PHMS polymer.

27. The pigment of claim 26, wherein said PHMS/PDMS copolymer is deposited on said surfaces of said inorganic pigment particles in an amount in the range of from about 0.5% by weight to about 5% by weight, and said neat PHMS polymer is deposited on the surfaces of said inorganic pigment particles in an amount in the range of from about 0.2% by weight to about 4% by weight, said weigh percentages being based on the combined weight of said inorganic pigment particles and said organic treating agent.
